(19) United States
(12) Patent Application Publication
(10) Pub. No.: US 2010/0218538 A1
(43) Pub. Date: Sep. 2, 2010

(54) ICE-CRUSHING UNIT FOR AN ICEMAKER

(75) Inventors: Martin Buchstab, Bopfingen (DE); Jürgen Diebold, Hermaringen (DE); Irene Dumkow, Sontheim (DE); Klaus Flinner, Zöschingen (DE); Markus Hanichl, Heidenheim (DE); Bernd Heger, Haunsheim (DE); Peter Nalbach, Iserlohn (DE); Martin Pünjer, Ulm (DE); Günter Raubold, Neu-Ulm (DE); Gerald Schmidt, Gerstetten (DE); Martin Schweyer, Bissingen (DE); Kasim Yazan, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/680,590

(22) PCT Filed: Sep. 9, 2008
(86) PCT No.: PCT/EP2008/061944

§ 371 Date: Mar. 29, 2010

(30) Foreign Application Priority Data
Oct. 1, 2007 (DE) 20 2007 013 714.1

(51) Int. Cl. F25C 5/02; B02C 18/06

(52) U.S. Cl. 62/320; 241/282.1

(57) ABSTRACT

An ice-crushing unit having a shaft, a plurality of axially-spaced stops disposed on the shaft, and a plurality of cutter sets provided on the shaft. A first cutter set may be rotationally fixed on the shaft and a second cutter set may be rotatable with the shaft or fixed to a housing. In an exemplary embodiment, the second cutter set is clamped in a longitudinal direction of the shaft by at least one spring acting in the longitudinal direction.

The present invention relates to an ice-crushing unit for an ice maker.

U.S. Pat. No. 4,176,527 discloses an ice-crushing unit having two cutter sets arranged on a shaft, of which the first is rotationally fixed on the shaft and the second can be optionally rotatable with the shaft or fixed to a housing of the unit. If the second cutter set is rotatable along with the first one, the cutter sets essentially act like a scoop which conveys the ice cubes intact to a dispensing opening of the ice-crushing unit. On the other hand, if the second cutter set is fixed to the housing, then it blocks the path of the ice cubes to the dispensing opening and the ice cubes are crushed between the cutter sets, so that only crushed ice reaches the dispensing opening.

In practice it has been shown that if the second cutter set is fixed to the housing it tends to work loose and temporarily rotate with the first cutter set until the attachment grips again. During this time, intact ice cubes can be dispensed, although this is not wanted by the user.

The object of the present invention is to specify an ice-crushing unit that offers a high degree of security against undesirable coupled rotation of the second cutter set.

Surprisingly it has been shown that the tendency of the second cutter set to work loose can be considerably reduced by clamping the second cutter set by at least one spring acting in the longitudinal direction of the shaft.

The spring is usefully embodied as a spring lock washer.

If the cutters of both cutter sets are axially movable on the shaft, a single spring is sufficient to clamp all cutters of the second cutter set, irrespective of their number and distribution along the shaft.

Each cutter set preferably contains at least one cutter disk with a collar pushed onto the shaft and a plurality of blades projecting radially from the collar.

If the second cutter set contains at least two such cutter disks, the free ends of the blades of different cutter disks of the second cutter set are preferably coupled to each other, so that the blades of the second set can only rotate together or not at all.

The blades of the second-set connecting bridging parts provide a large and secure working surface to which a locking bar can engage in order to fix the blades to the housing.

Furthermore, it is useful if each of the cutter disks of the first and of the second set has a different number of blades. This ensures that not all blades of the first set simultaneously pass those of the second set and not all blades of one cutter disk can be simultaneously blocked by ice cubes. The number of blades per set is preferably two or three, respectively.

Further features and advantages of the invention are revealed in the following description of exemplary embodiments with reference to the accompanying figures, wherein:

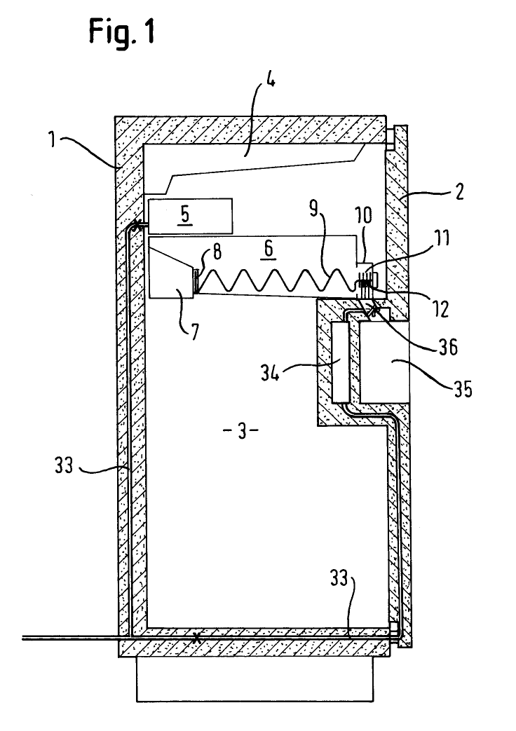

FIG. 1 shows a schematic section through a domestic appliance that is equipped with an inventive ice-crushing unit;

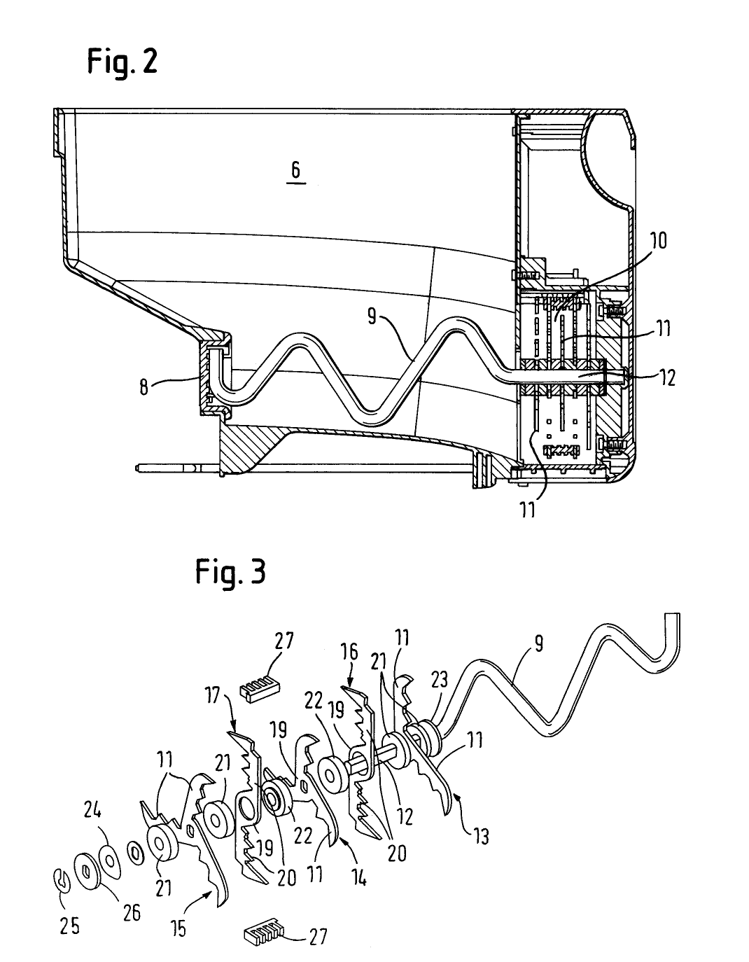

FIG. 2 shows a section through an ice storage compartment with integral crushing unit according to the present invention;

FIG. 3 shows an exploded view of the shaft and the blades of the crushing unit of FIG. 2;

FIG. 4 shows a radial section through the ice-crushing unit of FIG. 2, with the dispensing opening closed; and

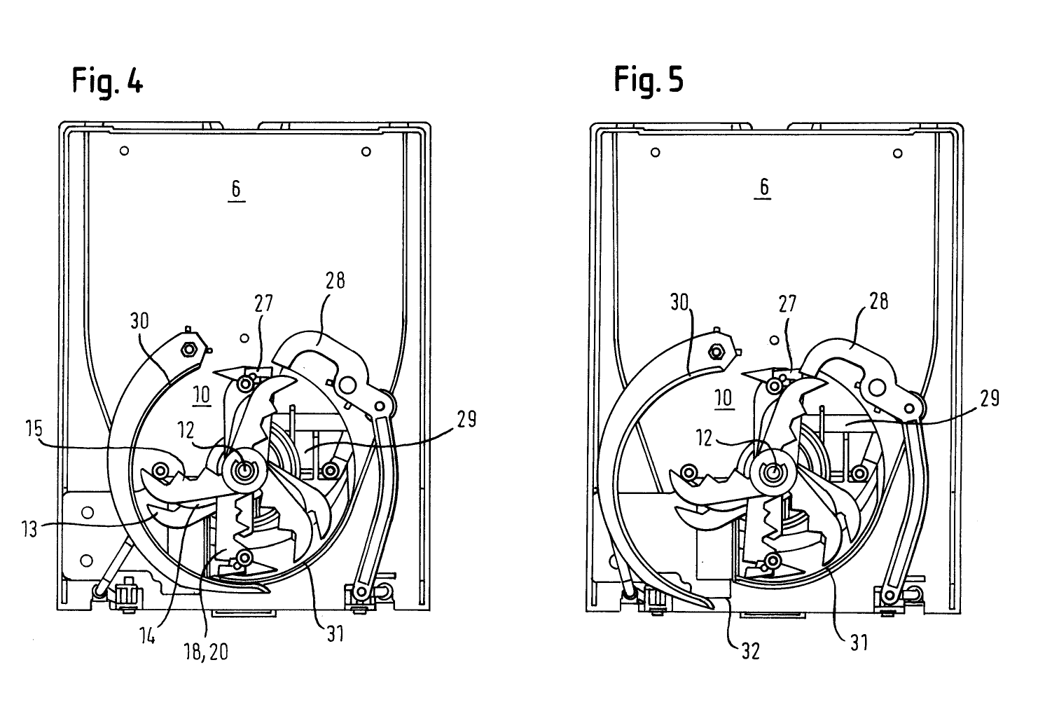

FIG. 5 shows a radial section through the ice-crushing unit with the dispensing opening open.

The refrigerating device shown in a schematic section in FIG. 1 has a thermally insulating body 1 and a door 2 which together delineate an inner space. The inner space 3 is cooled and maintained at a temperature below 0° C. by an evaporator which is housed in an evaporator chamber 4 divided off in the upper area of the body 1. An automatic ice maker 5 is located immediately adjacent to the evaporator chamber 4 in the inner space 3, so that it can preferably be supplied with cold air from the evaporator chamber 4. In a known manner and not shown in detail in the figure, the ice maker 5 contains a plurality of ice cube molds, means for automatically dosing water into the ice cube molds, as well as means for automatically ejecting the manufactured ice cubes from the ice cube molds. The ice maker is supplied with water via a pipe 33 connected to a domestic water supply, which also feeds a tank 34 of a cold water dispenser built into the rear wall of a cut-out 35 in the door 2.

A collecting chamber 6 of an ice dispenser which receives the ejected ice cubes, is located under the ice maker 5. The collecting chamber 6 extends over a large part of the depth of the inner space 3. An electric motor 7 which via an adapter part 8 drives an agitator rod 9 extending in the longitudinal direction of the collecting chamber 6, is housed in a cut-out at the rear side of the collecting chamber. The adapter part 8 which supports a rear end of the agitator rod 9 is retained in a rotatable but axially immovable manner in an opening in the rear side of the collecting chamber 6. In order to drive the agitator rod 9, a drive shaft of the electric motor 7 engages positively in the rear cut-outs of the adapter part 8. The collecting chamber is guided on rails into the body 1 and can be withdrawn; if it is withdrawn the engagement between the drive shaft of the motor 7 and the adapter part 9 is lost; engagement is re-established when the collecting chamber 6 is inserted again.

In a plane that is parallel to its axis of rotation, the agitator rod 9 is a metal rod bent into a zigzag shape and at a front end runs in a linear manner along the axis of rotation. Due to its planar shape, unlike a helix or a screw, it exerts no conveying force in the axial direction on ice cubes contained in the collecting chamber 6, rather it moves these in random directions and thus prevents these freezing to each other over a large area. The agitator rod 9 can therefore be rotated by the motor 7 from time to time, even if no ice is to be dispensed.

As can be seen in particular from FIG. 2, a dispensing chamber 10, through which the linear end section 12 of the agitator rod 9 extends, adjoins the collecting chamber 6 at the side facing away from the motor 7. The end section 12 carries a plurality of rotatable blades 11 which, by rotation of the agitator rod 9, are used to crush ice cubes arriving at the dispensing chamber 10. The function and arrangement of the blades 11, the agitator rod 9 and the components of an ice-crushing unit arranged thereon and to which the blades 11 belong, is more clearly illustrated in the exploded representation in FIG. 3. Two types of cutter disks 13, 14, 15 and 16, 17 are arranged at the end section 12 of the agitator rod 9. All cutter disks have a central collar 19 with an opening through which the end section 12 extends, and blades 11 and 20 respectively, projecting radially from the collar. In the case of the cutter disks 13, 14, 15 which are pushed onto the agitator rod 9 and rotationally fixed thereto, the opening in the collar 19 in each case is eccentric and adapted to the cross-section of the end section 12, so that these cutter disks 13, 14, 15 are driven by rotation of the agitator rod 9. The orientation of the blades 11 in relation to the opening in the collar 19, is always slightly different in the three cutter disks 13, 14, 15, so that the blades 11 are not aligned with each other when the cutter disks 13, 14, 15 are mounted on the end section 12. In each case the collars 19 of the cutter disks 16, 17 have larger openings which allow rotation of the cutter disks 16, 17 in relation to the agitator rod 9.

All of the cutter disks 13 to 17 are separated from each other by plastic pads 21, 22 of an essentially cylindrical shape, and by a flange 23 fixed to the agitator rod 9. Two of the plastic pads, denoted by 22, carry a projection which engages with the openings in the cutter disks 16. The pads 21, 22 and cutter disks 13 to 17 are pre-loaded in the axial direction by a spring lock washer 24 which is clamped between the foremost pad 21 and a washer 26 secured to the tip of the agitator rod 9 by a circlip 25. The spring lock washer 24 ensures that, irrespective of the manufacturing tolerances and in spite of different coefficients of thermal expansion of the agitator rod 9, of the cutter disks 13 to 17 and of the pads 21, 22, the cutter disks 13 to 17 are clamped in place between the pads 21, 22 so that, on the one hand they do not move significantly in the axial direction when ice is being crushed, and on the other hand the agitator rod 9 with the cutter disks 13, 14, 15 is still able to rotate even if the cutter disks 16, 17 are locked at the walls of the dispensing chamber 10.

In order to lock the cutter disks 16, 17, on the one hand two bridging parts 27 are used and are intended to be fixed to the outer radial ends of the blades 20 and thus couple the cutter disks 16, 17 together to form one rigid unit, and on the other hand a pivoted arm 28 is used, which is mounted on the housing of the ice-crushing unit and can be pivoted between two positions shown in FIGS. 4 and 5. In the position of FIG. 4, the tip of the pivoted arm 28 does not engage with the dispensing chamber 10 and the cutter disks 16, 17 are moved during rotation of the agitator rod 9. If there is room in the dispensing chamber 10, an ice cube set in motion in the collecting chamber 6 by the rotation of the agitator rod 9, can enter the dispensing chamber 10

through an opening 29. In the configuration of FIG. 4 the dispensing chamber 10 is of course closed so that no ice can escape.

To open the dispensing chamber 10, a roughly semi-cylindrical part 30 of its wall is pivoted on one side about an axis located at the upper edge of the dispensing chamber 10, as shown in FIG. 5, so that an opening 32 appears between this part 30 and a complementary, fixed wall part 31 at the bottom of the dispensing chamber 10. By rotating the agitator rod 9 clockwise, ice cubes are conveyed from the inlet opening 20 at the fixed wall part 31 along to the dispensing opening 32; they do not pass the wall part 30 that is pivoted at one side. The ice cubes pass through the dispensing opening 32 into a chute 36 which extends through the door 2 into the cut-out 35, and finally into a container installed in the cut-out 35.

FIG. 5 shows the pivoted arm 28 in a configuration in which its tip engages slightly with the dispensing chamber 10 and makes contact with one of the bridging parts 27. In this configuration the pivoted arm 28 blocks rotation of the cutter disks 16, 17 and each time ice cubes enter the dispensing chamber they are crushed between the rotating blades 11 and the blades 20 before reaching the opening 32. Due to the staggered orientation of the cutter disks 13, 14, 15, an ice cube is not trapped simultaneously between more than two blades 11 and 20. One individual ice cube cannot therefore block the rotation of the agitator rod 9. Since axial movement of the blades is prevented by the spring lock washer 24, the bridging parts 27 are also essentially immovable during the crushing operation, and a small overlap between the pivoted arm 28 and the bridging part 27 is sufficient to reliably lock the blades 20 and prevent loosening.

1-12. (canceled)

13. An ice-crushing unit, comprising:
a shaft;
a plurality of axially-spaced stops disposed on the shaft; and
a plurality of cutter sets provided on the shaft, of which a first cutter set is rotationally fixed on the shaft and a second cutter set is one of rotatable with the shaft and fixed to a housing, wherein the second cutter set is clamped in a longitudinal direction of the shaft by at least one spring acting in the longitudinal direction.

14. The ice-crushing unit as claimed in claim 13, wherein the at least one spring is a coiled spring.

15. The ice-crushing unit as claimed in claim 13, wherein the at least one spring is at least one of a spring lock washer and a disk spring.

16. The ice-crushing unit as claimed in claim 13, wherein the at least one spring is operable to press the plurality of cutter sets against one another.

17. The ice-crushing unit as claimed in claim 13, wherein the at least one spring is operable to press the plurality of cutter sets against at least one of the plurality of axially-spaced stops.

18. The ice-crushing unit as claimed in claim 13, wherein at least one of the plurality of axially-spaced stops is a detachable stop.

19. The ice-crushing unit as claimed in claim 13, wherein blades of the plurality of cutter sets are axially movable on the shaft.

20. The ice-crushing unit as claimed in claim 13, wherein each of the plurality of cutter sets includes at least one cutter disk having a collar operable to be pushed onto the shaft and a plurality of blades radially projecting from the collar.

21. The ice-crushing unit as claimed in claim 20, wherein at least the second cutter set includes at least two cutter disks and wherein free ends of the plurality of blades of different cutter disks of the second cutter set are coupled to one another.

22. The ice-crushing unit as claimed in claim 21, wherein the plurality of blades are connected by bridging parts with which a locking bar engages in a fixed state at the housing.

23. The ice-crushing unit as claimed in claim 20, wherein each of the cutter disks of the first and of the second set has a different number of blades.

24. The ice-crushing unit as claimed in claim 23, wherein each of the cutter disks of the first cutter set includes two blades and each of the cutter disks of the second cutter set includes three blades.
